(19) United States
(12) Patent Application Publication
(10) Pub. No.: US 2025/0388155 A1
(43) Pub. Date: Dec. 25, 2025

(54) AUTO-FOLDING HEADREST FOR A VEHICLE

(71) Applicants: HYUNDAI MOTOR COMPANY, Seoul (KR); KIA CORPORATION, Seoul (KR); HYUNDAI TRANSYS INC., Seosan-si (KR); KWANG MYUNG IND. CO., LTD., Gwangmyeong-si (KR)

(72) Inventors: Kiryung Lee, Hwaseong-si (KR); Sang Ho Kim, Hwaseong-si (KR); Sanguk Yu, Hwaseong-si (KR); Kangwon Kim, Hwaseong-si (KR); Dongjin Kim, Anseong-si (KR); Jinsik Kim, Suwon-si (KR); Jaeho Yeo, Seoul (KR); Ha Gyun Joung, Cheongju-si (KR); Byung Hoon Yoo, Seongnam-si (KR); Kook Hee Lee, Suwon-si (KR); Seung Jun Na, Asan-si (KR); Minho Kang, Hwaseong-si (KR)

(73) Assignees: HYUNDAI MOTOR COMPANY, Seoul (KR); KIA CORPORATION, Seoul (KR); HYUNDAI TRANSYS INC., Seosan-si (KR); KWANG MYUNG IND. CO., LTD., Gwangmyeong-si (KR)

(21) Appl. No.: 18/939,332

(22) Filed: Nov. 6, 2024

(30) Foreign Application Priority Data
Jun. 21, 2024 (KR) 10-2024-0080811

(51) Int. Cl. B60N 2/844

(52) U.S. Cl. CPC B60N 2/844

(57) ABSTRACT

An auto-folding headrest for a vehicle according to an embodiment of the present disclosure includes: a base bracket assembly configured to be fixedly installed on a seat frame constituting a seat of the vehicle; a stay assembly rotatably connected to the base bracket assembly and configured to support the headrest of the vehicle; a locking assembly provided on the base bracket assembly and configured to be changed into a locked state or an unlocked state to fix or release a rotation of the stay assembly; and a sliding bar coupled to the locking assembly and configured to change the locking assembly into the locked state or the unlocked state by a sliding operation.

### CROSS-REFERENCE TO RELATED APPLICATION

This application claims priority to and the benefit of Korean Patent Application No. 10-2024-0080811 filed in the Korean Intellectual Property Office on Jun. 21, 2024, the entire contents of which are incorporated herein by reference.

### BACKGROUND

### (a) Technical Field

The present disclosure relates to an auto-folding headrest for a vehicle, and more particularly, to an auto-folding headrest structure for a vehicle, which is configured to automatically fold by unlocking by an operation of a sliding bar and a return spring.

### (b) Description of the Related Art

Generally, a vehicle seat includes a seat cushion that supports the hips when a passenger is seated, a seatback that supports the back and the waist of the passenger, a headrest that supports the neck and the head of the passenger, and the like.

FIGS. 1-3 show a headrest folding structure of a vehicle of the related art. Referring to FIGS. 1-3, the headrest folding structure includes a headrest support 2, a housing 3, a release lever 4, a ratchet 5, and a lock link 6 installed inside the housing 3. When a cable C connected to one end of the release lever 4 is pulled downward in a use state of a headrest, the release lever 4 rotates, which indirectly rotates the lock link 6 through a rotation of the ratchet 5. The rotation of the lock link 6 rotates the headrest support 2 so that the headrest mounted on the headrest support 2 is folded toward the front of the vehicle.

The method of the related art is a method of indirectly operating the lock link 6 through the ratchet 5 without directly connecting an operation of the release lever 4 to an operation of the lock link 6, and each configuration requires a return spring, which increases the number of parts added for rotations of three configurations. This has problems of increasing production costs and causing product defects and structural operation errors because each part needs to be processed very precisely when assembling the headrest folding structure.

### SUMMARY

The present disclosure attempts to provide an auto-folding headrest structure for a vehicle with simplified parts. The auto-folding headrest structure is configured to automatically fold by adopting locking and unlocking methods by an operation of a sliding bar and a return spring.

An auto-folding headrest of a vehicle (i.e., an auto-folding headrest for a vehicle) according to an embodiment of the present disclosure includes: a base bracket assembly configured to be fixedly installed on a seat frame constituting a seat of the vehicle; a stay assembly rotatably connected to the base bracket assembly and configured to support the headrest of the vehicle; a locking assembly provided in the base bracket assembly and configured to be changed into a locked state or an unlocked state to fix or release a rotation of the stay assembly; and a sliding bar coupled to the locking assembly and configured to change the locking assembly into the locked state or the unlocked state by a sliding operation.

The stay assembly may include: a stay rod configured to contact and support the headrest; a support bracket connected to the stay rod and gear-coupled to the locking assembly; and an auxiliary bracket connected to the support bracket and configured to rotate to rotate the stay rod.

The support bracket may be in contact with and supported by the stay rod inside the base bracket assembly. The auxiliary bracket may be in contact with and supported by the stay rod outside the base bracket assembly. The support bracket and the auxiliary bracket may be coaxially connected to each other with the base bracket assembly disposed therebetween.

The locking assembly may include: a locking member configured to move back and forth inside the base bracket assembly to be coupled to or uncoupled from the support bracket and operate such that the support bracket rotates or is rotatably fixed; a sleeve having one side fixed to an inner surface of the base bracket assembly and the other side coupled to the locking member to provide a movement path for the locking member; a return spring provided on an outer circumference of the sleeve and configured to apply a compression force such that the locking member is coupled to the support bracket; and a fixing pin disposed and configured to simultaneously penetrate the locking member and the sleeve, connect the locking member to the sleeve, and limit a movement distance of the locking member with respect to the sleeve.

The return spring may operate to rotate the stay rod by rotating the auxiliary bracket by an elastic force of the return spring when the locking member is released from gear coupling to the support bracket.

The return spring may include (e.g., be configured as) a helical coil spring (also referred to as a heli coil spring).

An end of the locking member and an end of the support bracket may be gear-coupled to each other by engagements between a plurality of protrusions, each having an inclined shape on one side.

The end of the locking member and the end of the support bracket may be in contact with each other and be slidably coupled to each other.

The base bracket assembly may include a seat fixing bracket unit fixed to the seat frame. The base bracket assembly may further include a bracket housing extending to the seat fixing bracket unit and having the locking assembly disposed inside. The sliding bar may penetrate through the bracket housing. The base bracket assembly may also include a stopper configured to protrude toward an inner surface of the bracket housing and contact the support bracket to limit a rotation of the support bracket.

The stopper may include a stopper pin penetrated through a side surface of the bracket housing, and a stopper tube coupled to one end of the stopper pin.

The stopper tube may be formed of a rubber material.

The bracket housing may include a damper in contact with the stay rod to prevent the stay rod from colliding with the bracket housing.

The damper may be formed of a rubber material.

The sliding bar may coaxially connect the locking assembly, the support bracket, and the auxiliary bracket to each other. A bushing may be provided at a coaxial connection part of the auxiliary bracket.

A push nut may be provided on an outer circumferential surface of the sliding bar to be interposed between the bracket housing and the auxiliary bracket.

The sliding bar may include: a head part protruding from outside of the support bracket to outside of the bracket housing; a cable may be connected to an opposite end of the head part; and the sliding bar that may move by an operation of the cable.

The fixing pin may be in contact with and supported by an outer circumferential surface of the sliding bar. The fixing pin may operate to move together with the locking assembly when the sliding bar moves.

According to an embodiment of the present disclosure, in the auto-folding headrest structure for the vehicle, a simplified structure capable of locking and unlocking by the operation of the sliding bar and the return spring is adopted, thereby simplifying processing of the configuration and reducing the production cost.

In addition, instead of employing the existing three springs, the folding operation is enabled by one return spring capable of compression, tension, and return, thereby reducing the possibility of product defects and operation errors.

### BRIEF DESCRIPTION OF THE DRAWINGS

FIG. 1 is a perspective view illustrating a front surface of a headrest folding structure of a vehicle of the related art.

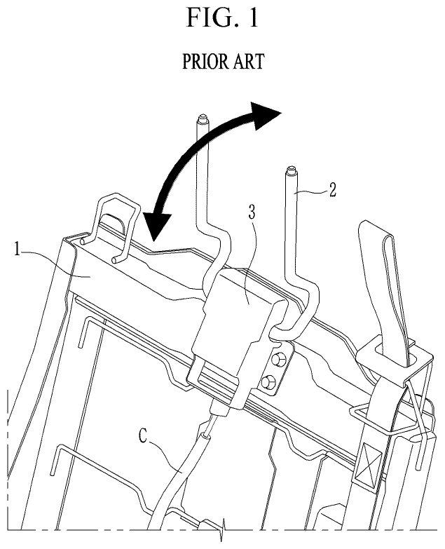

FIG. 2 is a perspective view illustrating a rear surface of the headrest folding structure of the vehicle of the related art.

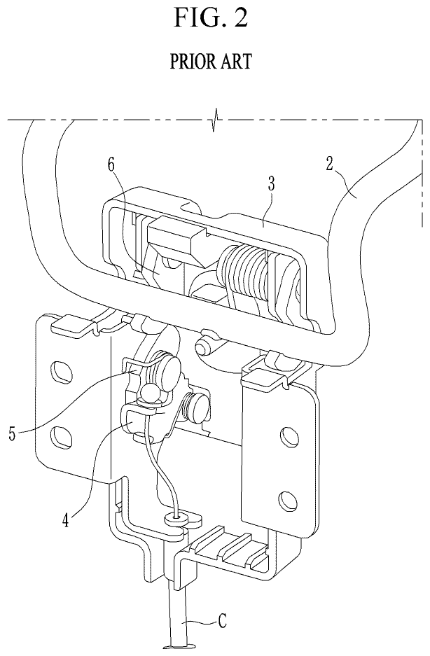

FIG. 3 is a cross-sectional view illustrating a folding operation of the headrest folding structure of the vehicle of the related art.

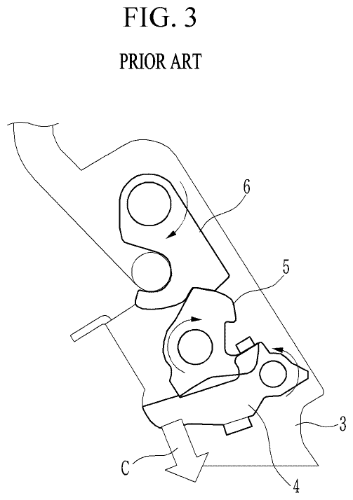

FIG. 4 is a perspective view illustrating a front surface of an auto-folding headrest structure for a vehicle according to an embodiment of the present disclosure.

FIG. 5 is a perspective view illustrating a rear surface of the auto-folding headrest structure according to an embodiment of the present disclosure.

FIG. 6 is an exploded perspective view of the auto-folding headrest structure according to an embodiment of the present disclosure.

FIG. 7 is a perspective view illustrating a base bracket assembly of the auto-folding headrest structure according to an embodiment of the present disclosure.

FIG. 8 is an exploded perspective view of the base bracket assembly of the auto-folding headrest structure according to an embodiment of the present disclosure.

FIG. 9 is a perspective view illustrating a stay assembly of the auto-folding headrest structure according to an embodiment of the present disclosure.

FIG. 10 is an exploded perspective view of the stay assembly of the auto-folding headrest structure according to an embodiment of the present disclosure.

FIG. 11 is a perspective view illustrating a locking assembly of the auto-folding headrest structure according to an embodiment of the present disclosure.

FIG. 12 is an exploded perspective view of the locking assembly of the auto-folding headrest structure according to an embodiment of the present disclosure.

FIG. 13 illustrates an initial use state of a headrest of the auto-folding headrest structure according to an embodiment of the present disclosure.

FIG. 14 illustrates an unlocked state of the locking assembly of the auto-folding headrest structure according to an embodiment of the present disclosure.

FIG. 15 illustrates a rotation and folding state of the stay assembly of the auto-folding headrest structure according to an embodiment of the present disclosure.

FIG. 16 illustrates a locked state of the auto-folding headrest structure after folding according to an embodiment of the present disclosure.

FIG. 17 illustrates a return state for using a headrest of the auto-folding headrest structure according to an embodiment of the present disclosure.

### DETAILED DESCRIPTION

The present disclosure is described more fully hereinafter with reference to the accompanying drawings, so that those having ordinary skill in the art to which the present disclosure pertains may easily implement embodiments of the present disclosure. However, the present disclosure may be implemented in many different forms and is not limited to the embodiments described herein.

In addition, in various embodiments, elements having the same configuration are typically described in an embodiment by using the same reference numerals, and in other embodiments, only different configurations have been described.

The drawings are schematic and not drawn to scale. Relative dimensions and ratios of parts in the drawings are shown exaggerated or reduced in size for clarity and convenience in the drawings. Any dimensions are illustrative only and not limiting. In addition, the same reference numerals are used to denote similar features in the same structure, element or parts appearing in two or more drawings. When an element is referred to as being “on” another element, it may be directly on the other element or intervening elements may also be accompanied.

The drawings of the present disclosure specifically represent an embodiment of the present disclosure. As a result, various modifications of drawings are expected. Therefore, an embodiment is not limited to a specific shape of an area shown, and includes, for example, a modification of the shape by manufacturing.

When a component, device, element, apparatus, or the like of the present disclosure is described as having a purpose or performing an operation, function, or the like, the component, device, element, apparatus, or the like should be considered herein as being “configured to” meet that purpose or to perform that operation or function.

Hereinafter, a structure of an auto-folding headrest 1000 for a vehicle according to an embodiment of the present disclosure is described in detail with reference to the accompanying drawings.

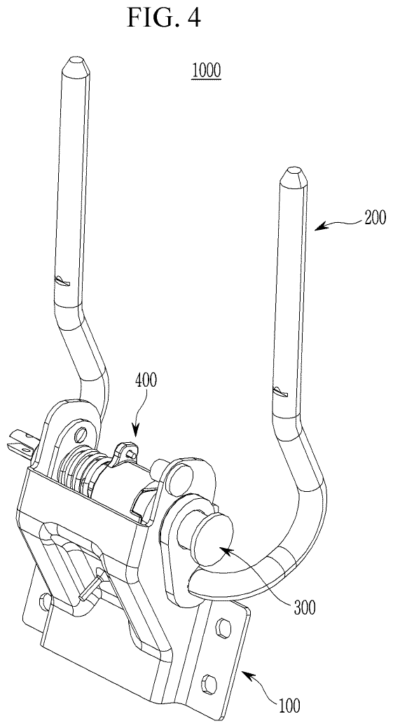

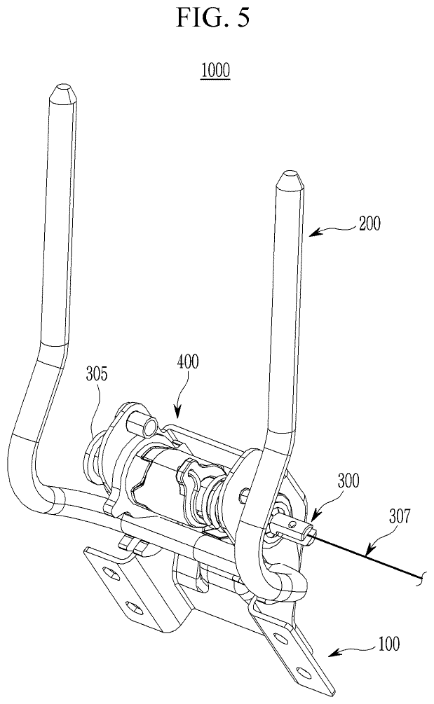

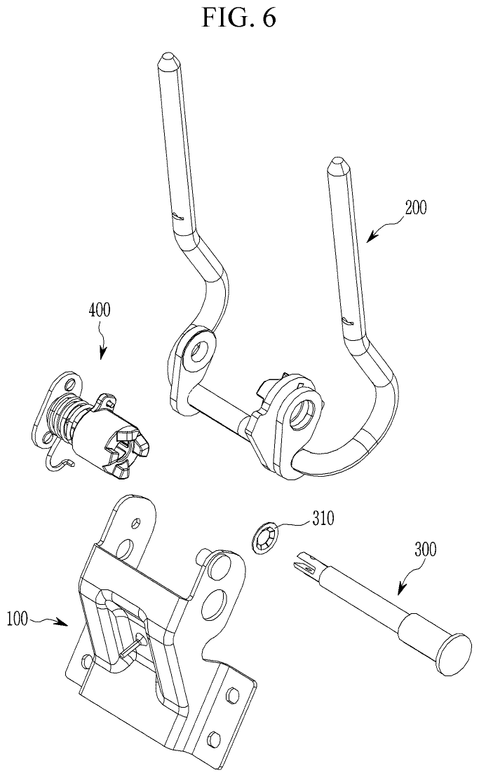

FIG. 4 is a perspective view illustrating a front surface of an auto-folding headrest structure for a vehicle according to an embodiment of the present disclosure. FIG. 5 is a perspective view illustrating a rear surface of the auto-folding headrest structure according to an embodiment of the present disclosure. FIG. 6 is an exploded perspective view of the auto-folding headrest structure according to an embodiment of the present disclosure.

Referring to FIGS. 4-6, the auto-folding headrest 1000 for the vehicle according to an embodiment of the present disclosure includes a base bracket assembly 100, a stay assembly 200, a locking assembly 400, and a sliding bar 300.

The base bracket assembly 100 is fixedly installed on a seat frame constituting a seat of the vehicle. The stay assembly 200 is rotatably connected to the base bracket assembly 100. The stay assembly 200 is configured to have lower portions connected to each other and upper portions extending in parallel to each other. A headrest is mounted on the upper portions of the stay assembly 200. The lower portions of the stay assembly 200 may protrude toward the rear of the base bracket assembly 100 and be formed in a curved shape.

The locking assembly 400 is provided on the base bracket assembly 100 and operates to be changed into a locked state or an unlocked state such that the stay assembly 200 may be fixed or released by rotating while being connected to the base bracket assembly 100.

The locking assembly 400 may be mounted to be accommodated in an upper inside of the base bracket assembly 100, and may operate to be coupled to or uncoupled from the stay assembly 200 on the inside of the base bracket assembly 100.

The sliding bar 300 may be coupled to the locking assembly 400 to change the locking assembly 400 into the locked state or the unlocked state in which the locking assembly 400 is coupled to or uncoupled from the stay assembly 200 by a sliding operation. In this way, the sliding bar 300 is slidably coupled to the locking assembly 400.

The sliding bar 300 may be coupled to (i.e., inserted into) the center of the locking assembly 400. In addition, the sliding bar 300 may be coupled to extend from the outside of the base bracket assembly 100 to the inside.

The sliding bar 300 includes a head part 305 protruding from the outside of a support bracket 220 to the outside of a bracket housing 120. A cable 307 may be connected to the opposite end of the head part 305. The sliding bar 300 may be moved by a manipulation of the cable 307.

In addition, a push nut 310 may be provided on an outer circumferential surface of the sliding bar 300 so as to be interposed between the bracket housing 120 and an auxiliary bracket 230.

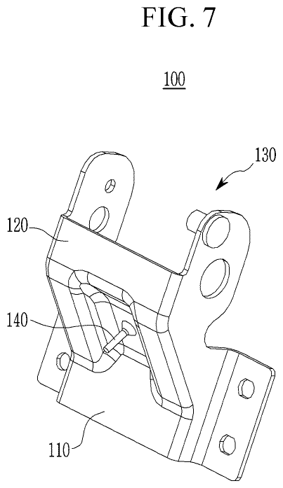

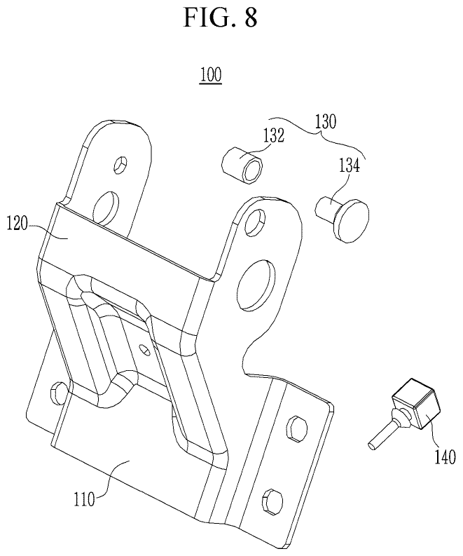

FIG. 7 is a perspective view illustrating a base bracket assembly of an auto-folding headrest structure for a vehicle according to an embodiment of the present disclosure. FIG. 8 is an exploded perspective view of the base bracket assembly of the auto-folding headrest structure according to an embodiment of the present disclosure.

Referring to FIGS. 7 and 8, the base bracket assembly 100 includes a seat fixing bracket unit 110 fixed to a seat frame, the bracket housing 120 extending from the seat fixing bracket unit 110, and a stopper 130 protruding toward an inner surface of the bracket housing 120.

The seat fixing bracket unit 110 may constitute a lower portion of the base bracket assembly 100, and may be in close contact with the seat frame and fixed by bolts and the like.

The bracket housing 120 may be provided to extend upward or outward (i.e., away from) from the seat fixing bracket unit 110, and the locking assembly 400 may be disposed therein. In addition, the sliding bar 300 may be disposed to penetrate and extend from the outside of the bracket housing 120 to the inside.

The stopper 130 may be disposed to protrude from an upper end of the bracket housing 120 toward an inner surface of the bracket housing 120. An opening is formed in the upper end of the bracket housing 120 so that the stopper 130 may be inserted into and fixed to the opening. The stopper 130 may include a stopper pin 134 and a stopper tube 132.

The stopper pin 134 is disposed to extend from the outside of the bracket housing 120 to the inside through the opening. The stopper tube 132 is coupled to an end of the stopper pin 134. The stopper tube 132 may be formed of a rubber material. The stopper tube 132 may contact the stay assembly 200 when the stay assembly 200 rotates upward. In this way, the stopper tube 132 serves to limit rotation.

A damper 140 that prevents a stay rod 210 from colliding with the bracket housing 120 when the stay assembly 200 rotates downward may be provided in the bracket housing 120. The damper 140 may be provided to protrude toward the inside of the bracket housing 120 and formed of a rubber material.

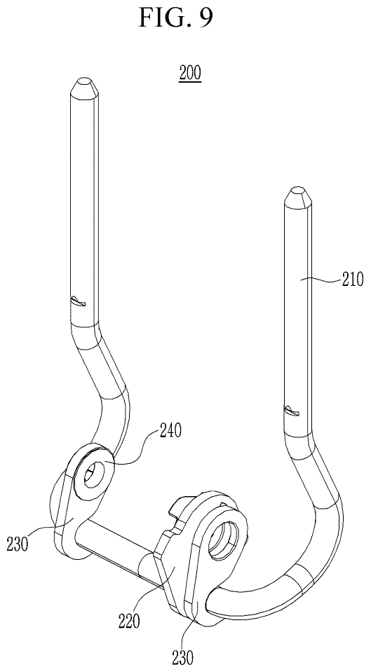

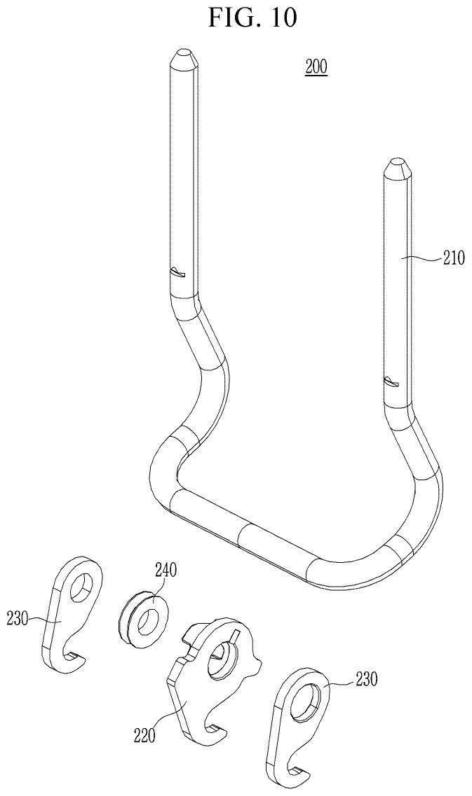

FIG. 9 is a perspective view illustrating a stay assembly of an auto-folding headrest structure for a vehicle according to an embodiment of the present disclosure. FIG. 10 is an exploded perspective view of the stay assembly of the auto-folding headrest structure according to an embodiment of the present disclosure.

Referring to FIGS. 9 and 10, the stay assembly 200 includes the stay rod 210, the support bracket 220, and the auxiliary brackets 230.

The stay rod 210 may be configured to extend upward so that lower portions are connected to each other and upper portions are in parallel to each other. A headrest may be mounted on the upper portions of the stay rod 210.

The auxiliary brackets 230 may be disposed on the lower portions of the stay rod 210 to face each other on both sides thereof. The auxiliary brackets 230 may have hook-shaped grooves and may be coupled to the stay rod 210 such that the lower portions of the stay rod 210 are inserted into the grooves.

The support bracket 220 may be connected to the inside of one of the auxiliary brackets 230. The support bracket 220 may also have a hook-shaped groove and may be coupled to the stay rod 210 such that the lower portion of the stay rod 210 is inserted into the groove of the support bracket 220. The support bracket 220 may be gear-coupled to the locking assembly 400, and may rotate according to an operation of the locking assembly 400.

The support bracket 220 and the auxiliary brackets 230 may be coaxially connected with the base bracket assembly 100 interposed therebetween. When the support bracket 220 rotates, the auxiliary brackets 230 connected thereto may rotate together, and the stay rod 210 connected to the support bracket 220 and the auxiliary brackets 230 may rotate. A bushing 240 may be interposed at a part of the auxiliary bracket 230 connected to the bracket housing 120.

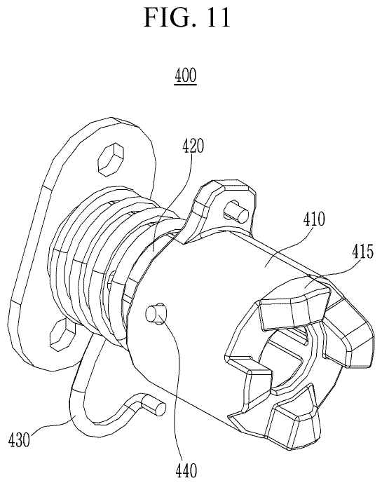

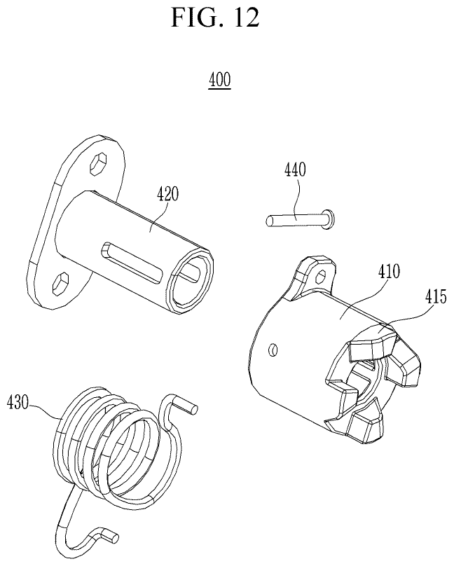

FIG. 11 is a perspective view illustrating a locking assembly of an auto-folding headrest structure for a vehicle according to an embodiment of the present disclosure. FIG. 12 is an exploded perspective view of the locking assembly of the auto-folding headrest structure according to an embodiment of the present disclosure.

Referring to FIGS. 11 and 12, the locking assembly 400 includes a locking member 410, a sleeve 420, a return spring 430, and a fixing pin 440.

The locking member 410 may move back and forth inside the base bracket assembly 100 to be coupled to or uncoupled from the support bracket 220 of the stay assembly 200 and operate such that the support bracket 220 may rotate or be rotatably fixed.

An end of the locking member 410 may be engaged with an end of the support bracket 220 to be gear-coupled. The end of the locking member 410 may include a plurality of protrusions 415, each having an inclined shape on one side. The end of the support bracket 220 may also include a plurality of protrusions, each having an inclined shape, such that the protrusions 415 of the end of the locking member 410 and the protrusions of the end of the support bracket 220 may be engaged with each other. When the end of the locking member 410 and the end of the support bracket 220 contact each other due to the protrusions, each having the inclined shape, the support bracket 220 may be engaged with the locking member 410 while simultaneously rotating and sliding. The stay assembly 200 rotates by the rotation of the support bracket 220.

The sleeve 420 is disposed and configured to be inserted into the locking member 410. One side of the sleeve 420 may be fixed to an inner surface of the base bracket assembly 100 by bolts and the like. The other side thereof may be coupled to (i.e., inserted into) the locking member 410 so that the locking member 410 may move in a longitudinal direction of the sleeve 420.

The return spring 430 is provided to be wound around an outer circumference of the sleeve 420. A compression force may be applied such that the locking member 410 contacts and is coupled to the support bracket 220.

In addition, when the locking member 410 is released from gear coupling to the support bracket 220, the return spring 430 may operate to rotate the stay rod 210 by rotating the auxiliary bracket 230 by an elastic force of the return spring 430. To this end, the return spring 430 may be configured as a heli coil spring.

The fixing pin 440 is disposed and configured to simultaneously penetrate the locking member 410 and the sleeve 420 to connect the locking member 410 to the sleeve 420, and may limit a movement distance of the locking member 410 with respect to the sleeve 420. The fixing pin 440 may be formed to have one end having a radius that is larger than a coupling opening of the locking member 410 so as not to be separated from the locking member 410.

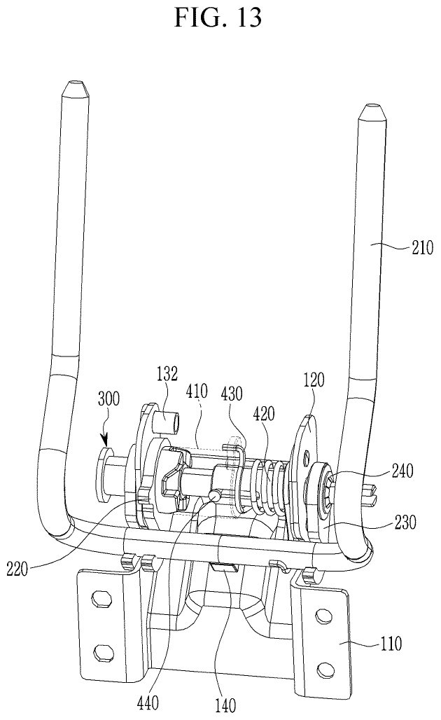

Hereinafter, an operation state of an auto-folding headrest structure of a vehicle according to an embodiment of the present disclosure is described with reference to FIGS. 13-17.

FIG. 13 illustrates an initial use state of a headrest of the auto-folding headrest structure according to an embodiment of the present disclosure.

Referring to FIG. 13, the locking member 410 is coupled to the support bracket 220 by a compression force of the return spring 430, in a state in which a user manually rotates and erects the stay rod 210 or the headrest mounted on the stay rod 210 in a vertical direction in order to use the headrest. The support bracket 220 and the auxiliary bracket 230 do not rotate and are fixed, and the stay rod 210 connected thereto also does not rotate and is fixed.

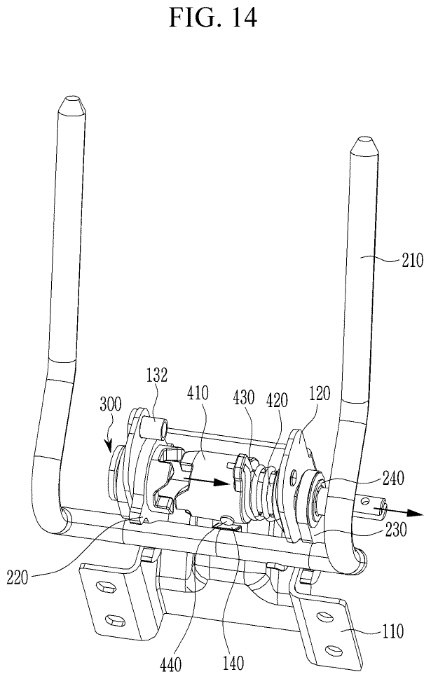

FIG. 14 illustrates an unlocked state of the locking assembly of the auto-folding headrest structure according to an embodiment of the present disclosure.

Referring to FIG. 14, the sliding bar 300 may be pulled by using a cable 307 connected to the opposite side of a head part 305 of the sliding bar 300 while pulling the sliding bar 300 toward the outside of the auxiliary bracket 230 in order to fold a headrest.

When the sliding bar 300 is pulled, the locking member 410 fixed to the sliding bar 300 by the fixing pin 440 moves along the sleeve 420 in a direction away from the support bracket 220, and the return spring 430 is compressed. In addition, gear coupling between the support bracket 220 and the locking member 410 is released.

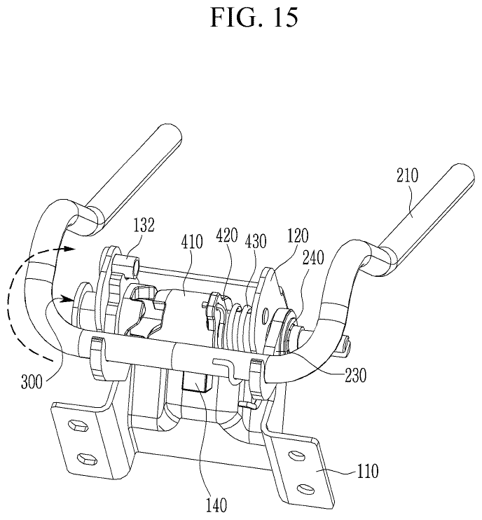

FIG. 15 illustrates a rotation and folding state of the stay assembly of the auto-folding headrest structure according to an embodiment of the present disclosure.

Referring to FIG. 15, when coupling between the locking member 410 and the support bracket 220 is released while the sliding bar 300 is being pulled, the sliding bar 300, the support bracket 220, and the auxiliary bracket 230 rotate by the compressed return spring 430. In addition, the stay rod 210 connected to the support bracket 220 and the auxiliary bracket 230 rotates. When the stay rod 210 rotates and contacts the stopper 130, the rotation of the stay rod 210 is stopped.

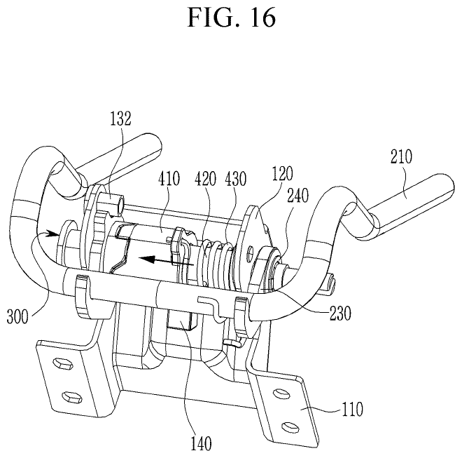

FIG. 16 illustrates a locked state of the auto-folding headrest structure after folding according to an embodiment of the present disclosure.

Referring to FIG. 16, when the sliding bar 300 is released after stopping pulling the sliding bar 300 in a state in which the stay rod 210 rotates, the locking member 410 moves again along the sleeve 420 toward the support bracket 220 by an elastic force of the return spring 430. Then, the locking member 410 and the support bracket 220 are fixed in contact with each other to be in the locked state.

According to the will of a user, a rotation amount of the stay rod 210, i.e., a folding angle of a headrest, may be adjusted by adjusting a time at which the sliding bar 300 is released while the stay rod 210 is rotating.

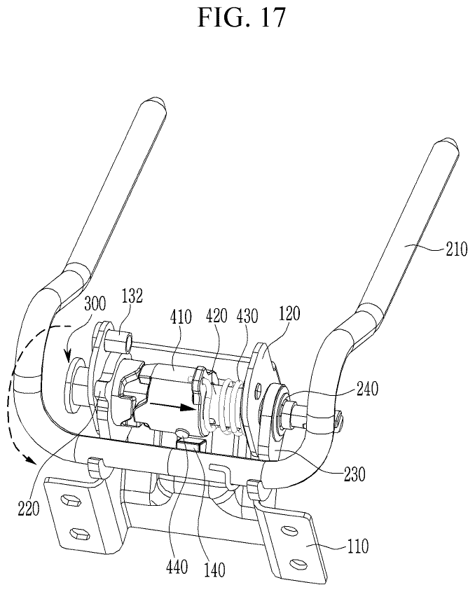

FIG. 17 illustrates a return state for using a headrest of the auto-folding headrest structure according to an embodiment of the present disclosure.

Referring to FIG. 17, when a user manually rotates and erects the stay rod 210 or a headrest in a vertical direction in a contact-fixing state between the locking member 410 and the support bracket 220, a plurality of protrusions, each having an inclined shape formed on the end of the support bracket 220 slide and rotate in contact with a plurality of protrusions 415, each having an inclined shape formed on the end of the locking member 410, briefly separate from each other, and then are again engaged with each other by a compression force of the return spring 430.

In other words, when the user manually rotates and erects the stay rod 210 or the headrest, the locking member 410 and the support bracket 220 rotate while contact therebetween is maintained by the compression force of the return spring 430. In addition, when the sliding bar 300 is pulled for headrest folding, the locking member 410 and the support bracket 220 are separated from each other by an elastic force of the return spring 430, and the support bracket 220 rotates such that the stay rod 210 and the headrest are automatically folded.

As described above, according to an embodiment of the present disclosure, in the auto-folding headrest structure for the vehicle, a simplified structure capable of locking and unlocking by the operation of the sliding bar and the return spring is adopted, thereby simplifying processing of the configuration and reducing the production cost.

In addition, instead of employing the conventional three springs, the folding operation is possible by one return spring capable of compression, tension, and return, thereby reducing the possibility of product defects and operation errors.

Although embodiments of the present disclosure have been described above, the present disclosure is not limited to the above embodiments. The present disclosure includes all modifications within the range easily changed and recognized as being equivalent by those of ordinary skill in the art to which the present disclosure pertains from embodiments of the present disclosure.

### DESCRIPTION OF SYMBOLS

1000: auto-folding headrest of vehicle
100: base bracket assembly
110: seat fixing bracket unit
120: bracket housing
130: stopper
132: stopper tube
134: stopper pin
140: damper
200: stay assembly
210: stay rod
220: support bracket
230: auxiliary bracket
240: bushing
300: sliding bar
310: push nut
400: locking assembly
410: locking member
420: sleeve
430: return spring
440: fixing pin

What is claimed is:

1. An auto-folding headrest for a vehicle comprising:
a base bracket assembly configured to be fixedly installed on a seat frame constituting a seat of the vehicle;
a stay assembly rotatably connected to the base bracket assembly and configured to support the headrest of the vehicle;
a locking assembly provided in the base bracket assembly and configured to be changed into a locked state or an unlocked state to fix or release a rotation of the stay assembly; and
a sliding bar coupled to the locking assembly and configured to change the locking assembly into the locked state or the unlocked state by a sliding operation.

2. The auto-folding headrest of claim 1, wherein the stay assembly includes:
a stay rod configured to contact and support the headrest;
a support bracket connected to the stay rod and gear-coupled to the locking assembly; and
an auxiliary bracket connected to the support bracket and configured to rotate to rotate the stay rod.

3. The auto-folding headrest of claim 2, wherein:
the support bracket is in contact with and supported by the stay rod inside the base bracket assembly;
the auxiliary bracket is in contact with and supported by the stay rod outside the base bracket assembly; and
the support bracket and the auxiliary bracket are coaxially connected to each other with the base bracket assembly disposed therebetween.

4. The auto-folding headrest of claim 3, wherein the locking assembly includes:
a locking member configured to move back and forth inside the base bracket assembly to be coupled to or uncoupled from the support bracket and operate such that the support bracket rotates or is rotatably fixed;
a sleeve having one side fixed to an inner surface of the base bracket assembly and the other side coupled to the locking member to provide a movement path for the locking member;
a return spring provided on an outer circumference of the sleeve and configured to apply a compression force such that the locking member is coupled to the support bracket; and
a fixing pin disposed and configured to simultaneously penetrate the locking member and the sleeve, connect the locking member to the sleeve, and limit a movement distance of the locking member with respect to the sleeve.

5. The auto-folding headrest of claim 4, wherein the return spring is configured to operate to rotate the stay rod by rotating the auxiliary bracket by an elastic force of the return spring when the locking member is released from gear coupling to the support bracket.

6. The auto-folding headrest of claim 5, wherein the return spring is a helical coil spring.

7. The auto-folding headrest of claim 4, wherein an end of the locking member and an end of the support bracket are gear-coupled to each other by engagements between a plurality of protrusions, each protrusion of the plurality of protrusions having an inclined shape on one side.

8. The auto-folding headrest of claim 7, wherein the end of the locking member and the end of the support bracket are in contact with each other and slidably coupled to each other.

9. The auto-folding headrest of claim 4, wherein the base bracket assembly includes:
a seat fixing bracket unit fixed to the seat frame;
a bracket housing extending to the seat fixing bracket unit and having the locking assembly disposed inside, wherein the sliding bar penetrates through the bracket housing; and
a stopper configured to protrude toward an inner surface of the bracket housing and contact the support bracket to limit a rotation of the support bracket.

10. The auto-folding headrest of claim 9, wherein the stopper includes:
a stopper pin penetrated through a side surface of the bracket housing; and
a stopper tube coupled to one end of the stopper pin.

11. The auto-folding headrest of claim 10, wherein the stopper tube is formed of a rubber material.

12. The auto-folding headrest of claim 9, wherein the bracket housing includes a damper in contact with the stay rod to prevent the stay rod from colliding with the bracket housing.

13. The auto-folding headrest of claim 12, wherein the damper is formed of a rubber material.

14. The auto-folding headrest of claim 9, wherein:
the sliding bar includes a head part protruding from outside of the support bracket to outside of the bracket housing;
a cable is connected to an opposite end of the head part; and
the sliding bar is configured to move by an operation of the cable.

15. The auto-folding headrest of claim 14, wherein the fixing pin is in contact with and supported by an outer circumferential surface of the sliding bar and operates to move together with the locking assembly when the sliding bar moves.

16. The auto-folding headrest of claim 2, wherein:
the sliding bar coaxially connects the locking assembly, the support bracket, and the auxiliary bracket to each other; and
a bushing is provided at a coaxial connection part of the auxiliary bracket.

17. The auto-folding headrest of claim 2, wherein a push nut is provided on an outer circumferential surface of the sliding bar to be interposed between a bracket housing and the auxiliary bracket.
